(19) United States
(12) Patent Application Publication
(10) Pub. No.: US 2021/0294122 A1
(43) Pub. Date: Sep. 23, 2021

(54) EYEGLASSES

(71) Applicant: Ifory Limited, Hong Kong (CN)

(72) Inventors: Yun FENG, Hong Kong (CN); Zhenhua LIU, Hong Kong (CN); Yong HUANG, Hong Kong (CN)

(73) Assignee: Ifory Limited, Hong Kong (CN)

(21) Appl. No.: 17/028,801

(22) Filed: Sep. 22, 2020

(30) Foreign Application Priority Data
Mar. 18, 2020 (CN) 202010189995.6

(51) Int. Cl. G02C 5/22; G02C 11/00

(52) U.S. Cl. CPC G02C 5/2209; G02C 11/10

(57) ABSTRACT

Disclosed are eyeglasses related to the wearable technology. The eyeglasses include a frame and two temples. Each of two ends of the frame includes a containing groove. Each temple includes a body structure and a connecting structure. One end of the body structure is rotatably connected to the connecting structure, and the other end of the body structure is oblique to the one end of the body structure. The connecting structure is capable of being in the containing groove. The connecting structure is detachably connected to the frame. In a case where the connecting structure moves away from the containing groove in a first direction, the connecting structure is capable of being disconnected from the frame. The first direction is perpendicular to the length direction of the frame.

### CROSS-REFERENCE TO RELATED APPLICATIONS

This application claims priority to a Chinese patent application No. 202010189995.6 filed on Mar. 18, 2020, the disclosure of which is incorporated herein by reference in its entirety.

### TECHNICAL FIELD

The present disclosure relates to the field of wearable technology and, in particular, to eyeglasses.

### BACKGROUND

Eyeglasses include a frame, temples connected to both ends of the frame, and lenses fixed to the frame and used for protecting eyes or correcting vision.

In the related art, the temples and the frame are fixedly connected through locking screws. Specifically, each end of the frame is provided with a protrusion, one end of each temple is provided with a groove matched with the protrusion, and the protrusion and a groove wall of the groove are each provided with a through hole. Each of the locking screws penetrates a through hole in a respective protrusion and a through hole in a respective groove wall to connect the frame and a respective temple, so that a user can conveniently wear the eyeglasses on ears.

However, because the locking screws are small, when the temples and the frame are detached, the operation difficulty is relatively large, and thus it is relatively difficult to detach the temples and the frame.

### SUMMARY

The present disclosure aims to provide eyeglasses which can reduce the operation difficulty of separating temples from a frame, so that the temples are easy to separate from the frame and thus the frame is easy to replace.

In view of the above, the technical solution adopted by the present disclosure is as below.

Eyeglasses include a frame and two temples.

Each of two ends of the frame includes a containing groove.

Each of the two temples includes a body structure and a connecting structure, one end of the body structure is rotatably connected to the connecting structure, the other end of the body structure is oblique to the one end of the body structure, the connecting structure is capable of being in the containing groove, the connecting structure is detachably connected to the frame, and in a case where the connecting structure moves away from the containing groove in a first direction, the connecting structure is capable of being disconnected from the frame, and the first direction is perpendicular to a length direction of the frame.

Optionally, the eyeglasses further include a first magnet in the containing groove. The connecting structure includes a second magnet, the second magnet is capable of being in the containing groove, and the second magnet is magnetically connected to the first magnet.

Optionally, the connecting structure further includes a connecting block, an surface at one side of the connecting block is provided with a protrusion, the second magnet is sleeved on and fixed to the protrusion, and the connecting block is rotatably connected to the body structure.

Optionally, one end of the body structure is provided with a protruding structure, the other side of the connecting block is provided with a groove, and the protruding structure is capable of being located in the groove and rotatably connected to the connecting block through the groove.

Optionally, the body structure further includes an ornamental portion, the ornamental portion is disposed between the second magnet and the body structure, and the ornamental portion is sleeved on the protruding structure.

Optionally, a mortise is disposed on the side wall of the containing groove, a tenon for mating with the mortise is disposed on an outer side of the connecting structure, and the connecting structure is connected to the frame through the tenon and the mortise mating with each other.

Optionally, a functional compartment is provided in the body structure, and the eyeglasses further include a microelectromechanical speaker and a control system which are disposed in the functional compartment.

Optionally, a sound hole of the microelectromechanical speaker is in the bottom wall of the body structure.

Optionally, the temple includes a connecting section and a bent section connected to each other.

The sound hole of the microelectromechanical speaker is in a part of the connecting section adjacent to the bent section, or the sound hole of the microelectromechanical speaker is in a part of the bent section adjacent to the connecting section.

Optionally, the eyeglasses further include a battery disposed in the bent section and a charging contact disposed on the connecting section and connected to the battery.

### BRIEF DESCRIPTION OF DRAWINGS

FIG. 1 is a schematic view illustrating the structure of eyeglasses according to an embodiment of the present disclosure;

FIG. 2 is a section view taken along line A-A of FIG. 1;

FIG. 3 is an enlarged view at position B shown in FIG. 2 according to the embodiment of the present disclosure;

FIG. 4 is a schematic view illustrating the structure of a connecting block according to the embodiment of the present disclosure;

FIG. 5 is a schematic view illustrating the structure of eyeglasses according to an embodiment of the present disclosure; and

FIG. 6 is a schematic view illustrating the structure of other eyeglasses according to an embodiment of the present disclosure.

In the drawings:

1. frame; 11. containing groove; 2. temple; 21. body structure; 211. protruding structure; 212. connecting section; 213. bent section; 214. ornamental portion; 22. connecting structure; 221. second magnet; 222. connecting block; 2221. groove; 2222. cambered surface; 223. protrusion; 224. outer projection; 23. functional compartment; 3. first magnet; 4. microelectromechanical speaker; 41. sound hole; 5. control system; 6. battery; 7. charging contact; 10. bone conduction headset module; 101. mainboard; 102. speaker unit; 103. vibration unit; and 104. button.

### DETAILED DESCRIPTION

To make the solved technical problems, the adopted technical solutions and the achieved technical effects in the present disclosure clearer, the technical solutions of the present disclosure will be further described below with reference to the drawings and embodiments. It is to be understood that the embodiment described here are only used for explaining the present disclosure, rather than limiting the present disclosure. In addition, it is to be noted that to facilitate description, the drawings show only part, not all, related to the present disclosure.

In the description of the present disclosure, it is to be noted that orientations or position relations indicated by terms “center”, “upper”, “lower”, “left”, “right”, “vertical”, “horizontal”, “in”, “out” and the like are orientations or position relations based on the drawings. These orientations or position relations are only for the convenience of describing the present disclosure and simplifying the description, and do not indicate or imply that a device or element referred to must have such specific orientations, or be configured or operated in such specific orientations. Thus, these orientations or position relations shall not be construed as limiting the present disclosure. In addition, terms “first”, “second” and the like are used for the purpose of description, and shall not be construed as indicating or implying relative importance.

In the description of the present disclosure, it is also to be noted that terms “mounted”, “joined” and “connected” shall be understood in a broad sense unless otherwise expressly specified and limited. For example, the term “connected” may refer to “fixedly connected” or “detachably connected”. In addition, the term “connected” may refer to “mechanically connected” or “electrically connected”. Further, the term “connected” may refer to “connected directly”, “connected indirectly through an intermediary” or “communicated in two components”. For those of ordinary skill in the art, specific meanings of the above terms in the present disclosure may be understood according to specific situations.

The present disclosure provides eyeglasses to make the temples 2 easy to separate from the frame 1 and the frame 1 easy to replace.

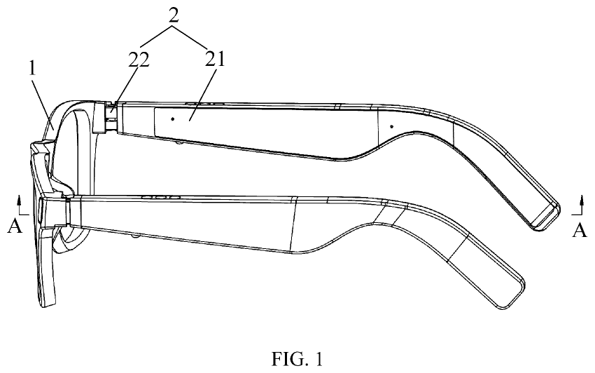

As shown in FIGS. 1 to 5, the eyeglasses include a frame 1 and two temples 2 both connected to the frame 1. The frame may be provided with two through holes. The two through holes can correspond to the eyes of a user. An edge of each end of the frame 1 is provided with a containing groove 11, and the containing groove 11 extends along a direction perpendicular to the frame 1.

Each temple 2 includes a body structure 21 and a connecting structure 22. One end of the body structure 21 is rotatably connected to the connecting structure 22, the other end of the body structure 21 is oblique to the one end of the body structure 21. That is, the extension direction of the body structure 21 and the extension direction of the connecting structure 22 have an included angle of less than 90 degrees so that the temples 2 can be worn on the ears of a user. The connecting structure 22 can be partially or completely in the containing groove 11 of the frame 1, and the connecting structure 22 is detachably connected to the frame 1. When the connecting structure 22 moves away from the containing groove 11 (or the frame 1) in a first direction, the connecting structure 22 can be disconnected from the frame 1. That is, when the frame 1 and the temples 2 need to be separated from each other, it is only necessary to control the temples 2 to move away from the frame 1 in the first direction. The first direction is perpendicular to the length direction of the frame 1. The length direction of the frame 1 may be the arrangement direction of the two through holes of the frame 1.

In the eyeglasses provided by the present embodiment of the present disclosure, each temple 2 is detachably connected to the frame 1 through a connecting structure 22. Temples 2 are separated from the frame 1 in the manner in which the temples 2 and the frame 1 move away from each other, that is, the detachable connection between the temples 2 and the frame 1 is released in the manner in which the temples 2 and the frame 1 move away from each other; and the temples 2 and the frame 1 are connected to each other in the manner in which the temples 2 and the frame 1 move towards each other. Thus, the operation difficulty of separating the temples 2 from the frame 1 is reduced, the temples 2 are easy to separate from the frame 1, and thereby the frame 1 is easy to replace.

Optionally, in this embodiment, the detachable connection manners of the frame 1 and the temples 2 may be various, and the following two connection manners are provided in the embodiment.

In one connection manner of the frame 1 and the temples 2, the frame 1 and the temples 2 are magnetically connected.

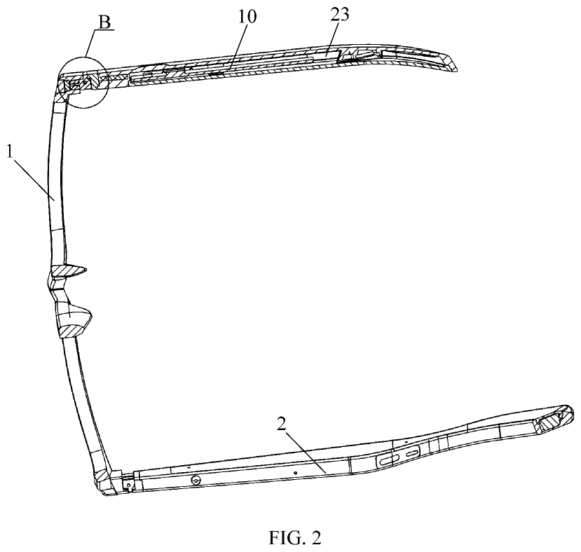

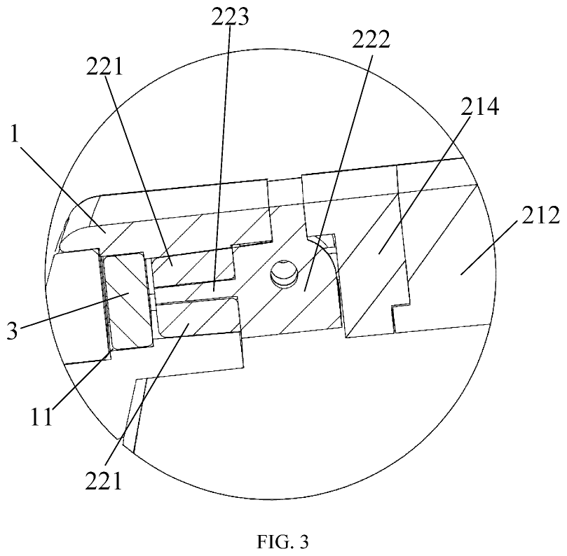

Optionally, as shown in FIGS. 2 and 3, the eyeglasses further include a first magnet 3 in each containing groove 11 of the frame 1, and the first magnet 3 is fixed in the containing groove 11. In this case, each connecting structure 22 may include a second magnet 221, the second magnet 221 can extend into the containing groove 11, and the second magnet 221 is magnetically connected to the first magnet 3 after extending into the containing groove 11, so that the frame 1 and the temples 2 can be magnetically connected. When the frame 1 and the temples 2 need to be separated from each other, the magnetic connection between the second magnet 221 and the first magnet 3 can be released as long as the temples 2 and the frame 1 are controlled to move away from each other, for example, the temples 2 are controlled to move away from the frame 1 along the first direction. When the frame 1 and the temples 2 need to be connected to each other, the second magnet 221 can be magnetically connected to the first magnet 3 as long as the temples 2 and the frame 1 are controlled to move towards each other, for example, the temples 2 are controlled to move towards the frame 1 along the first direction.

Alternatively, the connecting structure 22 may also not include the second magnet 221, and in this case, the material of the connecting structure 22 may be a magnetic material so that the connecting structure 22 can be magnetically connected to the first magnet 3 directly.

In this connection manner, as shown in FIG. 3, the connecting structure 22 may further include a connecting block 222. The connecting block 222 can be rotatably connected to the body structure 21, and an surface at one side of the connecting block 222 (that is, the side of the connecting block 222 towards the containing groove 11) is provided with an outwardly bulging protrusion 223, and the second magnet 221 is provided with a connecting hole or a connecting groove, so that the second magnet 221 can be sleeved on and fixed to the protrusion 223 through the connecting hole or the connecting groove. Optionally, the interior wall of the connecting hole or the connecting groove may be provided with a viscous substance so that the second magnet 221 can be bonded to the protrusion 223, or the second magnet 221 and the protrusion 223 can also be connected in the snap-fit manner to improve the connection strength of the second magnet 221 and the protrusion 223 and prevent the separation of the second magnet 221 and the protrusion 223.

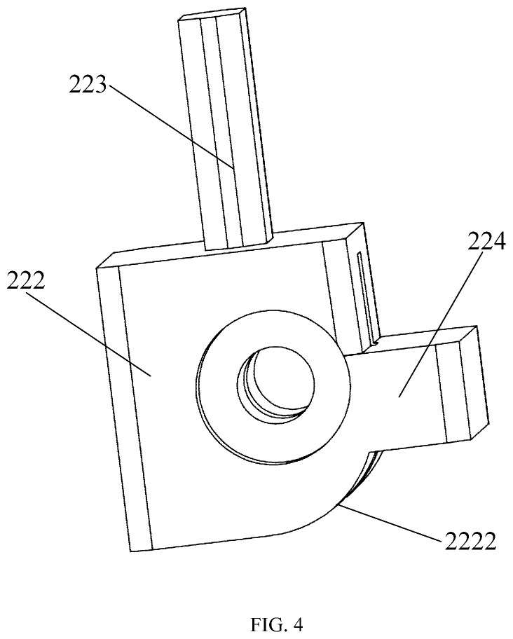

As shown in FIG. 4, the surface of the connecting block 222 on which the protrusion 223 is disposed may be a plane, and the surface of the connecting block 222 opposite to the protrusion 223 may be a cambered surface 2222. The arrangement of the cambered surface 2222 can facilitate the rotation of the body structure 21 relative to the connecting block 222 and avoid impeding the movement of the body structure 21.

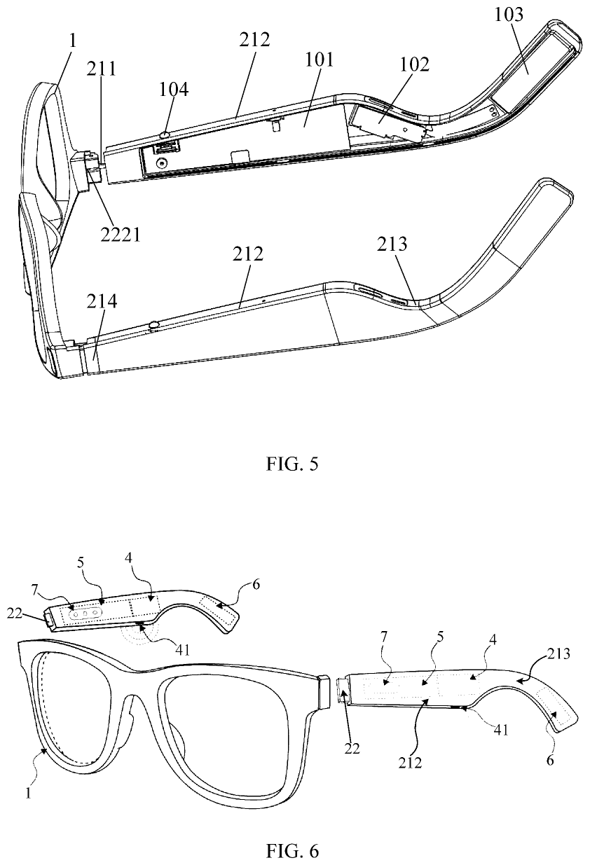

In this embodiment, as shown in FIG. 5, one end of the body structure 21 is provided with a protruding structure 211. The other side of the connecting block 222 (that is, the side opposite to the side of the connecting block 222 on which the protrusion 223 is disposed) is provided with a groove 2221. One end of the protruding structure 211 can be located in the groove 2221 and rotatably connected to the connecting block 222 through the groove 2221.

Optionally, one end of the protruding structure 211 may be provided with a first insertion hole, and the side wall of the groove 2221 is provided with a second insertion hole matching with the first insertion hole. In this case, the eyeglasses may further include pins. The pin is inserted to the first insertion hole and the second insertion hole so that the protruding structure 211 may be rotated around the pin, and thereby the protruding structure 211 is rotatably connected to the connecting block 222.

Optionally, as shown in FIG. 3, the body structure 21 further includes an ornamental portion 214. The ornamental portion 214 is between the second magnet 221 and the body structure 21. Optionally, the ornamental portion 214 is disposed between the body structure and the connecting block 222 and sleeved on the protruding structure 211. Due to the ornamental portion 214 disposed, there is no gap between the body structure 21 and the connecting structure 22, thereby the structure of the temple 2 can be more compact, and thus the temple 2 can be more aesthetic.

Optionally, the end part of one end of the ornamental portion 214 may be provided with a bulge. In this case, as shown in FIG. 4, the side end of the connecting block 222 is provided with an outer projection 224. The outer projection 224 can cooperate with the bulge to prevent a gap from existing in the temple 2, and then prevent the accumulation of dust on the temple 2.

In another connection manner of the frame 1 and the temples 2, the frame 1 and the temples 2 are mechanical self-locking connected through a riveting structure.

Optionally, a mortise may be disposed on the side wall of the containing groove 11, and in this case, a tenon for mating with the mortise is disposed on an outer side of the connecting structure 22 so that the connecting structure 22 can be connected to the frame 1 through the tenon and the mortise mating with each other. When the temples 2 and the frame 1 need to be separated from each other, as long as the temples 2 and the frame 1 are controlled to move away from each other, for example, the connecting structure 22 is controlled to move away from the containing groove 11 along the first direction, the tenon can leave the mortise under the external force, so that the riveting between the mortise and the tenon is released. When the frame 1 and the temples 2 need to be connected to each other, as long as the temples 2 and the frame 1 are controlled to move towards each other, for example, the connecting structure 22 is controlled to move towards the containing groove 11 along the first direction, the tenon can be inserted to the mortise under the external force, so that the tenon and the mortise can be riveted.

Optionally, in this connection manner, the connecting structure 22 may also include a connecting block 222. In this case, the outer surface of the connecting block 222 may also be provided with a tenon, and the one side of the connecting block 222 may not be provided with a protrusion 223. But other structures of the connecting block 222 may refer to the structures in the above connection manner, and the specific structure of the body structure 21 may also refer to the body structure 21 in the above connection manner, which is not described herein.

Optionally, as shown in FIG. 5, the body structure 21 may include a connecting section 212 and a bent section 213, one end of the connecting section 212 is connected to the connecting structure 22, and the other end of the connecting section 212 is connected to the bent section 213. The arrangement of the bent section 213 and the coordinating between the bent section 213 and the connecting sections 212 can facilitate the temples 2 to be worn on the ears of a user and the bent section 213 can be in contact with the ears of a user when the user wears the eyeglasses.

In this embodiment, as shown in FIG. 2, a functional compartment 23 is disposed in the body structure 21, and the functional compartment 23 is used for storing functional elements such as speakers, bone conduction structures, etc.

Optionally, according to the different specific functions of the temples 2, the structures in the temples 2 (that is, in the functional compartments 23) may be various, and two structures of the temples 2 are provided in the embodiment.

In one structure of the temples 2, as shown in FIGS. 2 and 5, the eyeglasses may include a bone conduction headset module 10 in the functional compartment 23. The bone conduction headset module 10 can have a function of a Bluetooth headset, and the bone conduction headset module 10 can be connected to a terminal (such as a mobile phone, etc.) through Bluetooth, so that messages can be transmitted to a user through the bone conduction headset module 10 when the terminal has the messages while the user wears the eyeglasses, to prevent the user from missing the messages.

Optionally, as shown in FIG. 5, the bone conduction headset module 10 may include a rechargeable battery, a motherboard 101 electrically connected to the rechargeable battery, and a charging port and a speaker unit 102 electrically connected to the motherboard 101. The rechargeable battery can be charged through a charging port. The charging port may be on the outer surface of the temple 2. An electronic device is integrated on the motherboard 101 so that the bone conduction headset module 10 has a Bluetooth function, etc.

Optionally, still referring to FIG. 5, the speaker unit 102 is on the bent section 213 of the temple 2 so that the sounds of the speaker unit 102 can be effectively transmitted to the ears of a user.

Optionally, as shown in FIG. 5, the bone conduction headset module 10 further includes a vibration unit 103 electrically connected to the motherboard 101, and the vibration unit 103 is at the end of the bent section 213, away from the connecting section 212, in the functional compartment 23. When a user wears the eyeglasses, the bent section 213 of the temple 2 can be in contact with the back of the ear of a user. When the bone conduction headset module 10 accesses the messages, the motherboard 101 may control the vibration of the vibration unit 103 to transmit the vibration to the user through the back of the ear of the user, so that when the environmental noise is excessive and the user cannot hear the sounds of the speaker unit 102, the messages can be received through the vibration unit 103, further avoiding the user missing the messages.

Optionally, the bone conduction headset module 10 further includes a button 104 fixed on the temple 2 and connected to the motherboard 101. The button 104 may be used to control the state of the bone conduction headset module 10 such as the power-on or power-off state of the bone conduction headset module 10.

In another structure of the temple 2, as shown in FIG. 6, the eyeglasses may include a microelectromechanical speaker 4 and a control system 5 in the functional compartment 23. The microelectromechanical speaker 4 has the advantages of small size, good sound effect, low costs and the like, and can be easy disposed in the temple 2.

Moreover, the microelectromechanical speaker 4 combines the classical semiconductor technology and the micron-scale micromachining technology, brings the change of the field of the speakers, enables the speaker to be manufactured in a large scale with low costs by silicon material like computer chips, has perfect sound effect pursuit by any combination number, and has good performance. The size of a microelectromechanical speaker 4 is 4*4 mm, and the microelectromechanical speaker 4 can cover the whole frequency range of 20 Hz˜20 kHz. The microelectromechanical speaker 4 can obtain 110 dB sound pressure equivalent to the noise level about 100 meters away from jet airplanes. Except the tiny size design, the microelectromechanical speaker 4 also has the advantages of high fidelity, low energy consumption, lower costs and reduced influence on the environment.

Optionally, as shown in FIG. 6, a sound hole 41 of the microelectromechanical speaker 4 is in the bottom wall of the body structure 21. That is, when a user wears the eyeglasses, the microelectromechanical speaker 4 is under the body structure 21 to be adjacent to the ear better.

Optionally, when the body structure 21 includes a connecting section 212 and a bent section 213, the sound hole 41 of the microelectromechanical speaker 4 is on the part of the connecting section 212 adjacent to the bent section 213 (as shown in FIG. 6), or the sound hole 41 of the microelectromechanical speaker 4 is on the part of the bent section 213 adjacent to the connecting section 212. That is, the sound hole 41 of the microelectromechanical speaker 4 is at a junction of the connecting section 212 and the bent section 213. The sound hole is disposed at the above position, so that the sound hole 41 is adjacent to the ears of a user, and thereby the microelectromechanical speaker 4 can directly play sounds near the ear to ensure that the user can effectively hear the sounds.

Optionally, still referring to FIG. 6, the eyeglasses further include a battery 6 electrically connected to the microelectromechanical speaker 4 and the control system 5 respectively, and a charging contact 7 connected to the battery 6. The battery 6 is in the bent section 213, and the charging contact 7 is disposed on the connecting section 212. The battery 6 can be charged through the charging contact 7 so that the battery can supply power to the microelectromechanical speaker 4 and the control system 5.

What is claimed is:

1. Eyeglasses, comprising:
a frame, wherein each of two ends of the frame comprises a containing groove; and
two temples, wherein each of the two temples comprises a body structure and a connecting structure, one end of the body structure is rotatably connected to the connecting structure, the other end of the body structure is oblique to the one end of the body structure, the connecting structure is capable of being in the containing groove, the connecting structure is detachably connected to the frame, and in a case where the connecting structure moves away from the containing groove in a first direction, the connecting structure is capable of being disconnected from the frame, wherein the first direction is perpendicular to a length direction of the frame.

2. The eyeglasses of claim 1, further comprising a first magnet in the containing groove, wherein the connecting structure comprises a second magnet, the second magnet is capable of being in the containing groove, and the second magnet is magnetically connected to the first magnet.

3. The eyeglasses of claim 2, wherein the connecting structure further comprises a connecting block, an surface at one side of the connecting block is provided with a protrusion, the second magnet is sleeved on and fixed to the protrusion, and the connecting block is rotatably connected to the body structure.

4. The eyeglasses of claim 3, wherein one end of the body structure is provided with a protruding structure, the other side of the connecting block is provided with a groove, and the protruding structure is capable of being located in the groove and rotatably connected to the connecting block through the groove.

5. The eyeglasses of claim 4, wherein the body structure further comprises an ornamental portion, the ornamental portion is disposed between the second magnet and the body structure, and the ornamental portion is sleeved on the protruding structure.

6. The eyeglasses of claim 1, wherein a mortise is disposed on a side wall of the containing groove, a tenon for mating with the mortise is disposed on an outer side of the connecting structure, and the connecting structure is connected to the frame through the tenon and the mortise mating with each other.

7. The eyeglasses of claim 1, wherein a functional compartment is provided in the body structure, and the eyeglasses further comprise a microelectromechanical speaker and a control system which are disposed in the functional compartment.

8. The eyeglasses of claim 2, wherein a functional compartment is provided in the body structure, and the eyeglasses further comprise a microelectromechanical speaker and a control system which are disposed in the functional compartment.

9. The eyeglasses of claim 3, wherein a functional compartment is provided in the body structure, and the eyeglasses further comprise a microelectromechanical speaker and a control system which are disposed in the functional compartment.

10. The eyeglasses of claim 4, wherein a functional compartment is provided in the body structure, and the eyeglasses further comprise a microelectromechanical speaker and a control system which are disposed in the functional compartment.

11. The eyeglasses of claim 5, wherein a functional compartment is provided in the body structure, and the eyeglasses further comprise a microelectromechanical speaker and a control system which are disposed in the functional compartment.

12. The eyeglasses of claim 6, wherein a functional compartment is provided in the body structure, and the eyeglasses further comprise a microelectromechanical speaker and a control system which are disposed in the functional compartment.

13. The eyeglasses of claim 7, wherein a sound hole of the microelectromechanical speaker is in a bottom wall of the body structure.

14. The eyeglasses of claim 8, wherein a sound hole of the microelectromechanical speaker is in a bottom wall of the body structure.

15. The eyeglasses of claim 9, wherein a sound hole of the microelectromechanical speaker is in a bottom wall of the body structure.

16. The eyeglasses of claim 10, wherein a sound hole of the microelectromechanical speaker is in a bottom wall of the body structure.

17. The eyeglasses of claim 11, wherein a sound hole of the microelectromechanical speaker is in a bottom wall of the body structure.

18. The eyeglasses of claim 12, wherein a sound hole of the microelectromechanical speaker is in a bottom wall of the body structure.

19. The eyeglasses of claim 13, wherein the body structure comprises a connecting section and a bent section connected to each other; and
wherein the sound hole of the microelectromechanical speaker is in a part of the connecting section adjacent to the bent section, or the sound hole of the microelectromechanical speaker is in a part of the bent section adjacent to the connecting section.

20. The eyeglasses of claim 19, further comprising:
a battery, disposed in the bent section; and
a charging contact, disposed on the connecting section and connected to the battery.
